(19) United States
(12) Patent Application Publication
(10) Pub. No.: US 2020/0162270 A1
(43) Pub. Date: May 21, 2020

(54) METHODS AND APPARATUS FOR SECURE CONTENT DELEGATION VIA SURROGATE SERVERS

(71) Applicant: IDAC HOLDINGS, INC., Wilmington, DE (US)

(72) Inventors: Hongfei Du, Surrey (GB); Dirk Trossen, London (GB)

(73) Assignee: IDAC HOLDINGS, INC., Wilmington, DE (US)

(21) Appl. No.: 16/627,647

(22) PCT Filed: Jun. 28, 2018
(86) PCT No.: PCT/US2018/040035

§ 371 Date: Dec. 30, 2019

Related U.S. Application Data
(60) Provisional application No. 62/527,379, filed on Jun. 30, 2017.

(51) Int. Cl. H04L 9/32; H04W 12/00; H04L 29/08; H04L 29/06

(52) U.S. Cl. CPC H04L 9/3268; H04L 63/0428; H04L 67/02; H04W 12/0017

(57) ABSTRACT

A delegation server may receive secure content from an origin server. The secure content may be pushed under a request-specific content handle comprising a unique mapping from a specific request to a specific response. The delegation server may receive name registration authority for a fully qualified domain name (FQDN) from the origin server and may register to the FQDN so that one or more Hypertext Transfer Protocol (HTTP) requests destined to the FQDN may be served by the delegation server. The delegation server may receive an HTTP request published to the FQDN by a client network access point (cNAP that includes the request-specific content handle calculated from a Hyper Text Transfer Protocol Secure (HTTPS) request from a client. The delegation server may send the secure content to the cNAP in an HTTP response. The secure content may be inserted into a HTTPS response towards the client.

### CROSS REFERENCE TO RELATED APPLICATIONS

This application claims the benefit of U.S. Provisional Application No. 62/527,379 file on Jun. 30, 2017, the contents of which is hereby incorporated by reference herein.

### BACKGROUND

Content on the Internet is often served by delegated authorities rather than an original server. This may be done to reduce latency and cost. In physical terms, delegation is very similar to how a manager may delegate responsibility of tasks to his or her staff. The results may be the same, but more than one person may be involved in the process. The manager may receive a request for work and may pass on the responsibility to another member of staff. Either the staff member or the manager may return with the work results.

### SUMMARY

Methods, systems, and apparatuses are disclosed for secure content delegation in an information centric network (ICN). A delegation server may receive secure content from an origin server. The secure content may be pushed under a request-specific content handle. The delegation server may receive name registration authority for a fully qualified domain name (FQDN) from the origin server. The delegation server may register to the FQDN, such that one or more Hypertext Transfer Protocol (HTTP) requests destined for the origin server can be served by the delegation server. The delegation server may receive an HTTP request for content associated with the request-specific content handle from a client network access point (cNAP). The request-specific content handle may be calculated from a Hyper Text Transfer Protocol Secure (HTTPS) request from a client. The delegation server may send the secure content to the cNAP in an HTTP response, such that the secure content is decrypted and inserted into a HTTPS response towards the client.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 1E is component diagram of a computing device;

FIG. 1F is a component diagram of a server;

FIG. 2 is a diagram illustrating delegation of content retrieval;

FIG. 3 is a diagram illustrating an Hypertext Transfer Protocol (HTTP)-over-information centric network (ICN) system with a Network Attachment Point (NAP)-based protocol mapping;

FIG. 4 is a flowchart illustrating a method of providing secure content delegation in a surrogate system;

FIG. 5 is a flow-chart illustrating a method of providing secure content delegation in a surrogate system using a cNAP with certificate delegation; and

FIG. 6 is a flow-chart illustrating a method of providing secure content delegation in a surrogate system using a browser plugin.

### DETAILED DESCRIPTION

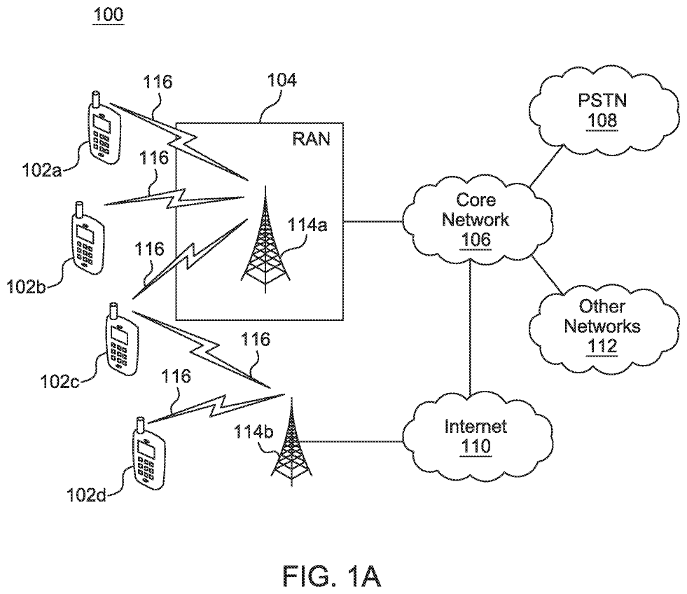

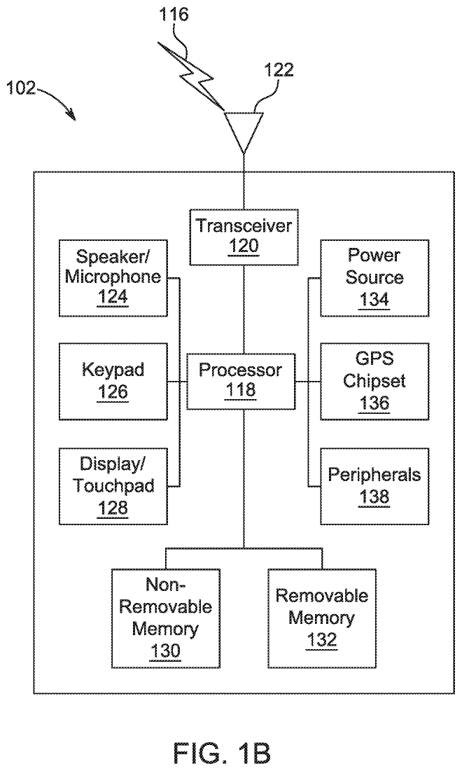

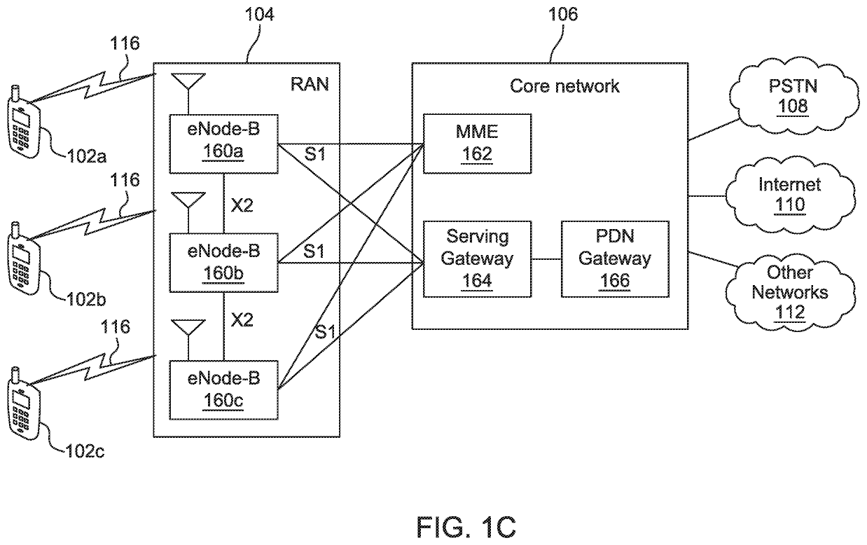

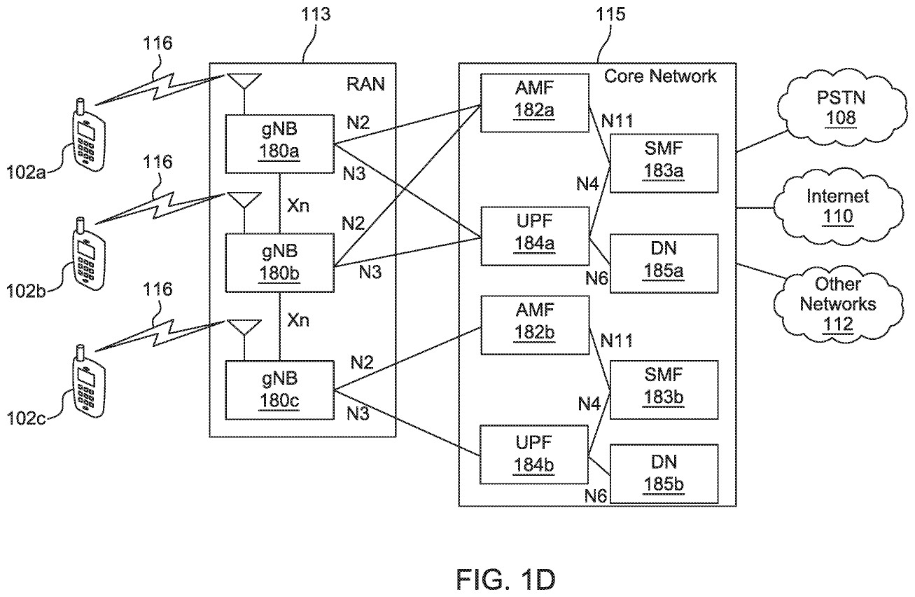

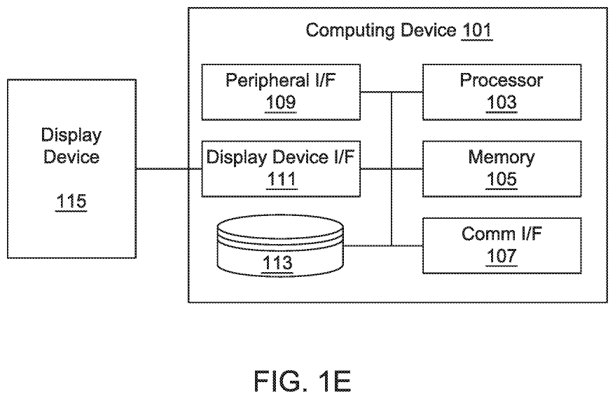

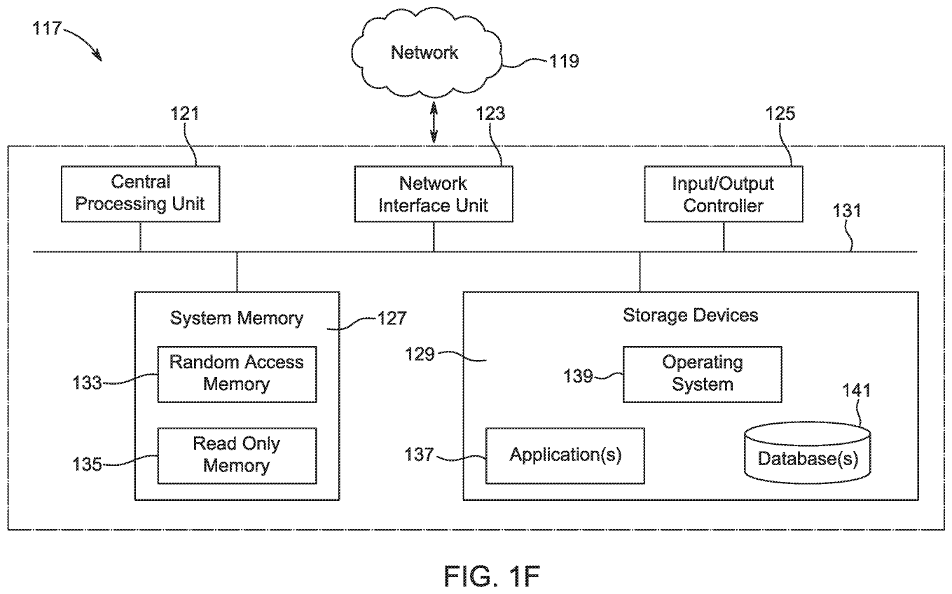

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Referring now to FIG. 1E, an example computing device 101 is shown. The computing device 101 may be implemented in the clients described below. The computing device 101 may include a processor 103, a memory device 105, a communication interface 107, a peripheral device interface 109, a display device interface 111, and a storage device 113. FIG. 1E also shows a display device 115, which may be coupled to or included within the computing device 101.

The memory device 105 may be or include a device such as a Dynamic Random Access Memory (D-RAM), Static RAM (S-RAM), or other RAM or a flash memory. The storage device 113 may be or include a hard disk, a magneto-optical medium, an optical medium such as a CD-ROM, a digital versatile disk (DVDs), or Blu-Ray disc (BD), or other type of device for electronic data storage.

The communication interface 107 may be, for example, a communications port, a wired transceiver, a wireless transceiver, and/or a network card. The communication interface 107 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 109 may be an interface configured to communicate with one or more peripheral devices. The peripheral device interface 109 may operate using a technology such as Universal Serial Bus (USB), PS/2, Bluetooth, infrared, serial port, parallel port, and/or other appropriate technology. The peripheral device interface 109 may, for example, receive input data from an input device such as a keyboard, a mouse, a trackball, a touch screen, a touch pad, a stylus pad, and/or other device. Alternatively or additionally, the peripheral device interface 109 may communicate output data to a printer that is attached to the computing device 101 via the peripheral device interface 109.

The display device interface 111 may be an interface configured to communicate data to display device 115. The display device 115 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 111 may operate using technology such as Video Graphics Array (VGA), Super VGA (S-VGA), Digital Visual Interface (DVI), High-Definition Multimedia Interface (HDMI), or other appropriate technology.

The display device interface 111 may communicate display data from the processor 103 to the display device 115 for display by the display device 115. As shown in FIG. 1E, the display device 115 may be external to the computing device 101, and coupled to the computing device 101 via the display device interface 111. Alternatively, the display device 115 may be included in the computing device 101.

An instance of the computing device 101 of FIG. 1E may be configured to perform any feature or any combination of features described above. In such an instance, the memory device 105 and/or the storage device 113 may store instructions which, when executed by the processor 103, cause the processor 103 to perform any feature or any combination of features described above. Alternatively or additionally, in such an instance, each or any of the features described above may be performed by the processor 103 in conjunction with the memory device 105, communication interface 107, peripheral device interface 109, display device interface 111, and/or storage device 113.

Although FIG. 1E shows that the computing device 101 includes a single processor 103, single memory device 105, single communication interface 107, single peripheral device interface 109, single display device interface 111, and single storage device 113, the computing device may include multiples of each or any combination of these components 103, 105, 107, 109, 111, 113, and may be configured to perform, mutatis mutandis, analogous functionality to that described above.

Referring now to FIG. 1F, a component diagram of a server 117 is shown. The server 117 may be a conventional stand-alone web server, a server system, a computing cluster, or any combination thereof. The server 117 may include a server rack, a data warehouse, network, or cloud type storage facility or mechanism that is in communication with a network 119. The server 117 may include one or more central processing units (CPU) 121, network interface units 123, input/output controllers 125, system memories 127, and storage devices 129. Each CPU 121, network interface unit 123, input/output controller 125, system memory 127, and storage devices 129 may be communicatively coupled via a bus 131.

The system memory 127 may include random access memory (RAM) 133, read only memory (ROM) 135, and one or more cache. The storage devices 129 may include one or more applications 137, an operating system 139, and one or more databases 141. The one or more databases 141 may include a relational database management system managed by Structured Query Language (SQL). The storage devices 129 may take the form of, but are not limited to, a diskette, hard drive, CD-ROM, thumb drive, hard file, or a Redundant Array of Independent Disks (RAID).

The server 117 may be accessed by the clients, as described below, via a network 119 using a mainframe, thin client, personal computer, mobile device, pad computer, or the like. Information processed by the CPU 121 and/or operated upon or stored on the storage devices 129 and/or in the system memory 127 may be displayed to a client through a user device.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

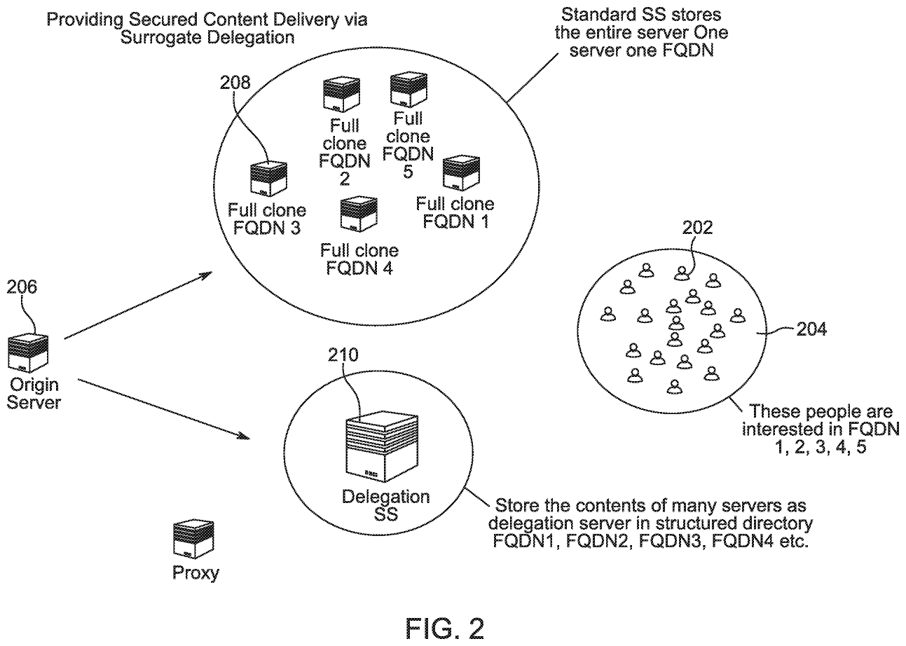

Referring now to FIG. 2, a diagram illustrating delegation of content retrieval is shown. As described above, delegation of content retrieval refers to the process of satisfying a content request to a specific content Uniform Resource Identifier (URI) by a delegation server different to a so-called origin server. The URI may be a string of characters used to identify a resource. As shown in FIG. 2, one or more users 202 may be co-located in a regional area 204. The one or more users 202 may be interested in content provided by one or more fully qualified domain names (FQDNs) at an origin server 206.

Instead of surrogating the entire contents for each FQDN into a full clone FQDN 208, content may be only partially available in a delegation surrogate server 210. The delegation surrogate server 210 may be operated under the FQDN authority, but may only act as a delegated authority for specific requests, to which they are able to respond based on previously seeded content. The operation of the delegation surrogate server may be outsourced to, for example, content delivery network (CDN) providers, which may only act on behalf of the FQDN authority for the specific content they are hosting. Given the lower trust relationship with the client as compared to the origin server, content may be assumed to be fully secured at the origin server with strict privacy requirements in terms of content confidentiality.

Delegation of content through the delegated surrogate server 210 may be realized through an initial request to the origin server 206, which may then provide an indirection to the delegation surrogate server 210. This inherent triangular routing via the origin server 206 may be detrimental to performance because of added response latency. Also, the client may need to appropriately act upon the indirection, which may not be transparent with respect to the original request. Conventional systems may use domain name service (DNS)-based indirection towards delegation servers. However, this delegation may require proper configuration of the appropriate DNS entries and may often fail due to stale client-local DNS cache entries being used instead of updated DNS values. Furthermore, secure delegation (i.e., delegation of secure content) may require full content authority for the delegation server, which may not be desirable for trust reasons. In other words, it may not be desirable for a content provider to hand over full content certificate authority to a CDN provider simply for reasons of possible delegation of otherwise secure content.

It may be desirable to avoid the issues associated with DNS and the triangular routing described above, for example, by flexibly directing Hypertext Transfer Protocol (HTTP)-level service requests to so-called surrogate service endpoints. These endpoints may be web-level resources that are exposed through the same FQDN (e.g., mydomain.com/foo). Default policies for routing may direct a service request to the topologically nearest instance. This concept may be applied to a CDN and surrogate service endpoints may be placed that appropriately direct resource requests.

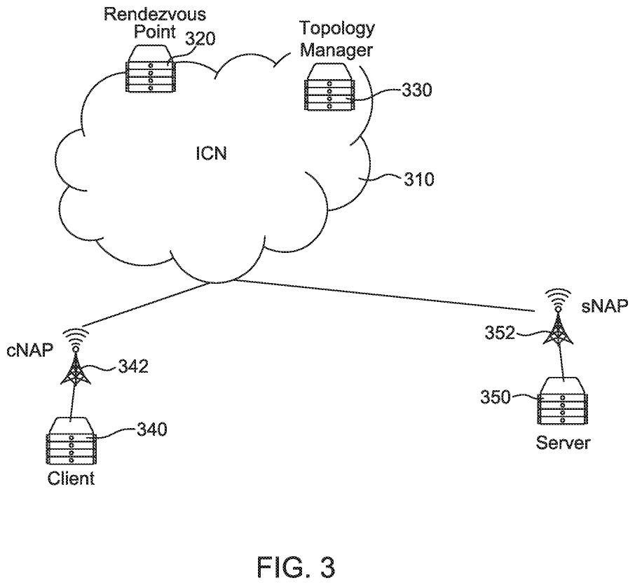

Referring now to FIG. 3, a diagram illustrating an HTTP-over-information centric network (ICN) system with a Network Attachment Point (NAP)-based protocol mapping is shown. IP-based applications may provide a broad range of Internet services. Transitioning these applications may require more than a pure transition of network-level functionality (e.g., protocol stack implementation) in the WTRU since such a transition may also require the transition of server-side components (e.g., e-shopping web-servers). Accordingly, IP-based services, and IP-based WTRUs, may continue to exist.

In order for ICN and HTTP/IP based services to coexist, there may be a gateway-based architecture where one or more NAPs translate IP and HTTP-level protocol abstractions of the Internet in ICN-compliant operations. As shown in FIG. 3, a gateway-based architecture may be used for intra-network communication. Border gateways may be used to communicate with IP devices in peer networks.

The ICN network 310 may include a client 340 and a server 350. The client 340 may be an IP-enabled device, such as, for example, the WTRU 102 or the computing device 101 described above. The server 350 may be similar to the server 117 described above. The client 340 may be coupled to the ICN network 310 by a first NAP 342. The server 350 may be coupled to the ICN network 310 by a second NAP 352. It should be noted that although the client 340 and the first NAP 342 are shown as separate entities in FIG. 3, the two entities may be co-located and combined into a single WTRU 102 or computing device 101. In addition, although the server 350 and the second NAP 352 are shown as separate entities in FIG. 3, the two entities may be co-located and combined into a single server 117. The client 340 may also locally host content.

The ICN network 310 may also include a rendezvous point (RVZ) 320 that allows for matching an HTTP client with a suitable server and a topology manager (TM) 330 that allows for creating a suitable forwarding path from the client 340 to the chosen server. The RVZ 320 may identify a needed communication between sender and receiver and the TM 330 may compute suitable forwarding information to deliver the packet from the sender to the receiver. It should be noted that the RVZ 320 and the TM 330 are shown as two logical functions, but may be implemented as a single component that combines the functions of the RVZ 320 and TM 330.

FIG. 3 illustrates a system for realizing the routing capability described above for HTTP requests. The first NAP 342 may be at the client side (i.e., a client NAP (cNAP)) and may provide suitable protocol translation into ICN-based message exchanges in order to direct an original HTTP request from the client 340 to the second NAP 352, which may be an appropriate server-side NAP (sNAP). However, this arrangement may not provide delegation capability. In other words, this arrangement may not allow for the satisfaction of requests by a third party (e.g., the provider of the delegation server) on behalf of the origin server without revealing the content to the delegation server provider.

The following description includes methods, systems, and apparatuses for allowing the use of delegation servers under the same FQDN as an origin server without exposing unencrypted content or content certificates to the delegation servers. This may preserve the privacy of the content towards the client and may replace the triangular routing described above with a more optimal nearest delegation server routing. Standard IP-based routing may be used with extensions to DNS routing.

In order to remove the inefficient triangular routing and to avoid handing any knowledge of the specific transaction to the possibly less trusted delegation service (e.g., a CDN provider), the following concepts may be implemented.

A request-specific determination of a content handle may be used that is different from the request URI usually used in HTTP transactions. This content handle may be a unique mapping from the specific request, including all relevant HTTP request parameters, to the specific response to the request. In order to remove the triangular routing, the determination of the content handle may be implemented at the client prior to contacting the delegation server.

Name registration authority may be separated from the content security, which may remain at the level of the encrypted content. The encryption may be based on the FQDN's certificate. In other words, the delegation server may rely on the capability to register the FQDN with the network-based resolution system, which may be the DNS or similar functionality. Requests destined for the FQDN may be served by the delegation server after registration authority has been granted, while the content may remain secure between the origin server and the client.

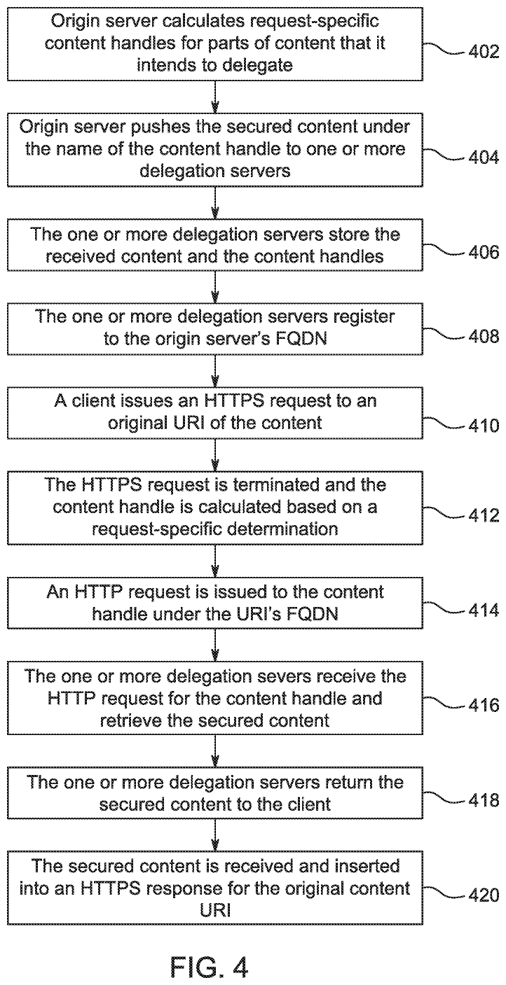

Referring now to FIG. 4, a flowchart illustrating a method of providing secure content delegation in a surrogate system is shown. In step 402, an origin server may calculate request-specific content handles for parts of content that it intends to delegate to one or more delegation servers. In step 404, the origin server may push the secure content under the name of the content handle to the one or more delegation servers. In step 406, the one or more delegation servers may store the received content and the content handles in an internal database for future retrieval.

The origin server may provide the one or more delegation servers with registration authority for its FQDN, including any possibly required certificate information. In step 408, the one or more delegation servers may use a suitable network-level registration mechanism to register the FQDN appropriately.

In step 410, a client may issue an HTTPS request to an original URI of the content. In step 412, the HTTPS request may be terminated, either at the client or at a cNAP, and the content handle may be calculated based on a request-specific determination.

In step, 414, an HTTP request may be issued to the content handle under the URI's FQDN. In step 416, the one or more delegation severs may receive the HTTP request for the content handle, and may retrieve the secure content from local storage. In step 418, the one or more delegation servers may return the secure content to the client.

In step 420, the client (or the cNAP) may receive the secure content and may insert the secure content into an HTTPS response for the original content URI.

As shown in FIG. 4, the secure content may be retrieved from the delegation server and handed all the way back to the client in a secure manner (i.e., encrypted). The client (or cNAP) may associate the response to the original handle request using the secure container and may send the HTTPS response. It is the request that is decrypted, either at the cNAP or the browser plugin, to calculate the PRID.

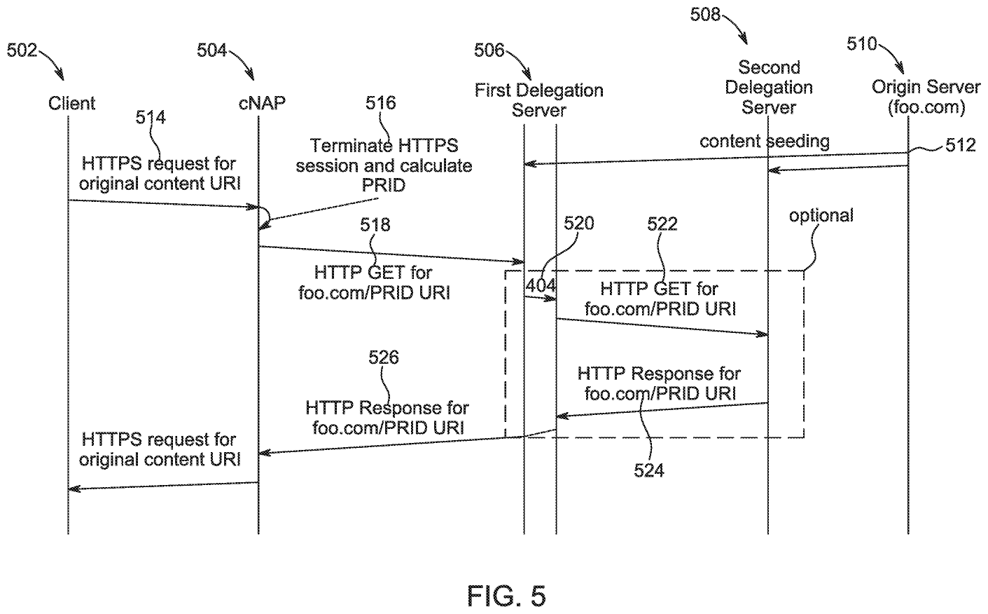

Referring now to FIG. 5, a flow-chart illustrating a method of providing secure content delegation in a surrogate system using a cNAP with certificate delegation is shown. FIG. 5 shows a message exchange for content seeding and retrieval, where the communication between a client 502, a cNAP 504, a first delegation server 506, a second delegation server 508, and an origin server 510 are illustrated via HTTP GET requests and responses. As described above, the client 502 may be connected to the cNAP 504 via an interface, or the client 502 and the cNAP 504 may be a single entity.

For content URI to be delegated, the origin server 510 (e.g., foo.com) may calculate a request-specific content handle (i.e., a proxy rule identifier (PRID)) for a content request. The PRID may uniquely identify the response to a specific request. The origin server 510 may encrypt content for the PRID using a certificate for the origin server 510 (e.g., foo.com).

In step 512, the origin server 510 may push secure content as a foo.com/PRID resource to the first delegation server 506 and, optionally, the second delegation server 508 using appropriate methods, such as HTTP PUT requests or FTP upload, or using an appropriate content management interface. The name authority certificate for the origin server 510 may be provided to the first delegation server 506 and the second delegation server 508 for certified registration under the FQDN (i.e., foo.com).

The first delegation server 506 and the second delegation server 508 may register as foo.com. In the HTTP over ICN system described above with reference to FIG. 3, a suitable registration interface may be used at network attachment points of the first delegation server 506 and the second delegation server 508. In standard IP routed systems, the origin server 510 may provide redirection capabilities to the first delegation server 506 and the second delegation server 508 by registering the first delegation server 506 and the second delegation server 508 as Canonical Name (CNAME) entries in the DNS. Alternative methods for registering delegation servers may be used to provide reachability for delegation servers under a given FQDN.

In step 514, the client 502 may issue an HTTPS request to the cNAP 504 for the original content URI. In step 516, the cNAP 504 may terminate the HTTPS session and may calculate the PRID, The cNAP 504 may decrypt the incoming HTTPS request and may calculate the PRID using suitable HTTP request parameters. The cNAP 504 may rewrite the https://foo.com/resource request into http://foo.com/PRID. The cNAP 504 may retrieve the necessary certificate from the origin server 510. The cNAP 504 may be provided the certificate by an origin service provider (e.g., through a web store or similar) and may act on the URI of the origin server 510. In step 518, the cNAP 504 may send a request for the foo.com/PRID resource using an HTTP GET message.

The HTTP GET message may be routed to the first delegation server 506. If the requested resource PRID is found, the first delegation server 506 may retrieve the resource and may send the secure content in a body of an HTTP response back to the cNAP 504.

Alternatively, as shown in step 520, if the requested resource PRID is not found at the first delegation server 506, it may issue a 404 Error. In step 522, the first delegation server 506 may redirect the HTTP request to the second delegation server 508. The first delegation server 506 may use CNAME redirection to redirect the request to the second delegation server 508, assuming an appropriate DNS configuration for the CNAME record entry in the DNS. If the requested resource PRID is found, the second delegation server 508 may retrieve the resource.

In step 524, the second delegation server 524 may send the secure content in a body of an HTTP response to the first delegation server 506. In step 526, the first delegation server 506 may send the secure content in a body of an HTTP response back to the cNAP 504.

The cNAP 504 may receive the HTTP response and associate the secure content with the original HTTPS session context, which may be stored at the cNAP 504. The cNAP 504 may insert the received (secure) content into an HTTPS response towards the client 502 using the session context information. In step 528, the cNAP 504 may send the HTTPS response to the client 502.

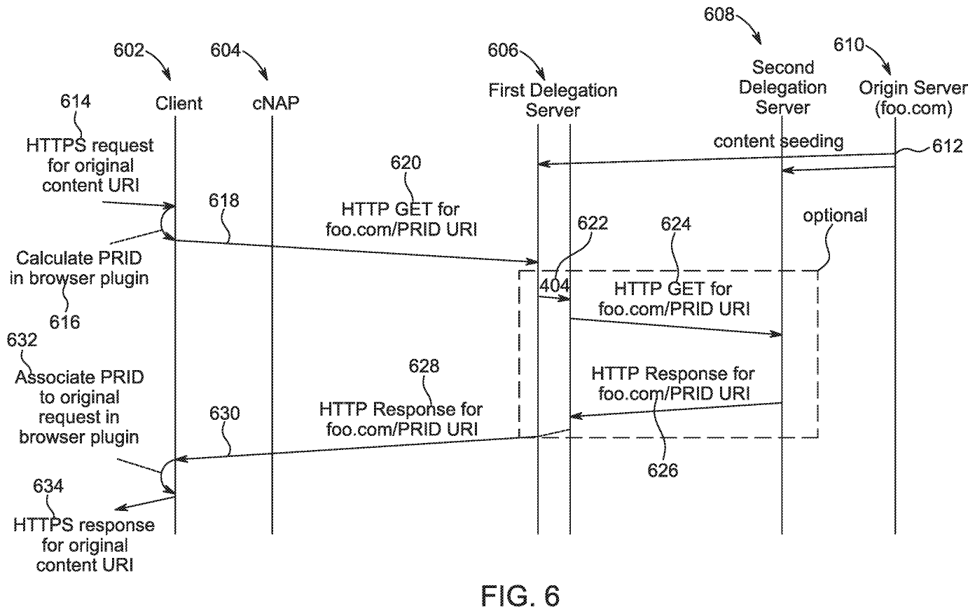

Referring now to FIG. 6, a flow-chart illustrating a method of providing secure content delegation in a surrogate system using a browser plugin is shown. FIG. 6 shows a message exchange for content seeding and retrieval, where the communication between a client 602, a cNAP 604, a first delegation server 606, a second delegation server 608, and an origin server 610 are illustrated via HTTP GET requests and responses. As described above, the client 602 may be connected to the cNAP 604 via an interface, or the client 602 and the cNAP 604 may be a single entity. As shown, the HTTPS termination for the request and response association may be delegated to a browser plugin at the client 602, which may avoid providing certificate delegation to the possibly untrusted cNAP 604.

For content URI to be delegated, the origin server 610 (e.g., foo.com) may calculate a request-specific content handle (i.e., a PRID) for a content request. The PRID may uniquely identify the response to a specific request. The origin server 610 may encrypt content for the PRID using a certificate for the origin server 610 (e.g., foo.com).

In step 612, the origin server 610 may push secure content as a foo.com/PRID resource to the first delegation server 606 and, optionally, the second delegation server 608 using appropriate methods, such as HTTP PUT requests or FTP upload, or using an appropriate content management interface. The certificate for the origin server 610 may be provided to the first delegation server 606 and the second delegation server 608 for certified registration under the FQDN (i.e., foo.com).

The first delegation server 606 and the second delegation server 608 may register as foo.com. In the HTTP over ICN system described above with reference to FIG. 3, a suitable registration interface may be used at network attachment points of the first delegation server 606 and the second delegation server 608. In standard IP routed systems, the origin server 610 may provide redirection capabilities to the first delegation server 606 and the second delegation server 608 by registering the first delegation server 606 and the second delegation server 608 as CNAME entries in the DNS. Alternative methods for registering delegation servers may be used to provide reachability for delegation servers under a given FQDN.

In step 614, the client 602 may issue an HTTPS request for the original content URI. In step 616, the browser plugin at the client 602 may terminate the HTTPS session and may calculate the PRID. The client 602 may decrypt the incoming HTTPS request and may calculate the PRID using suitable HTTP request parameters. The browser plugin may rewrite the https://foo.com/resource request into http://foo.com/PRID. The browser plugin may retrieve the necessary certificate from the origin server 610. The browser plugin may be provided by the origin service provider directly (e.g., through a web store or similar) with the certificate being part of the plug-in installation. Using the certificate, the browser plugin may act on the URI of the origin server 610. In step 618, the client 602 may send an HTTP request for the foo.com/PRID resource to the cNAP 604. The client 602 may maintain an internal table that associates the HTTPS session context with the publication of the foo.com/PRID resource for future responses.

In step 620, the cNAP may send the HTTP request for the foo.com/PRID resource using an HTTP GET message. The HTTP GET message may be routed to the first delegation server 606. If the requested resource PRID is found, the first delegation server 606 may retrieve the resource and may send the secure content in a body of an HTTP response back to the cNAP 604.

Alternatively, as shown in step 622, if the requested resource PRID is not found at the first delegation server 606, it may issue a 404 Error. In step 624, the first delegation server 606 may redirect the HTTP request to the second delegation server 608. The first delegation server 606 nay use CNAME redirection to redirect the request to the second delegation server 608, assuming an appropriate DNS configuration for the CNAME record entry in the DNS. If the requested resource PRID is found, the second delegation server 608 may retrieve the resource.

In step 626, the second delegation server 624 may send the secure content in a body of an HTTP response to the first delegation server 606. In step 628, the first delegation server 606 may send the secure content in a body of an HTTP response back to the cNAP 604.

In step 630, the cNAP 604 may forward the HTTP response to the client 602. In step 632, the browser plugin may receive the HTTP response and associate the secure content with the original HTTPS session context, which may be stored at the client 602. The browser plugin may insert the received (secure) content into an HTTPS response using the session context information. In step 634, the browser plugin may deliver the HTTPS response to the client 602.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of secure content delegation for use in a delegation server in an information centric network (ICN), the method comprising:
receiving secure content from an origin server, wherein the secure content is pushed under a request-specific content handle;
receiving name registration authority for a fully qualified domain name (FQDN) from the origin server;
registering to the FQDN, such that one or more Hypertext Transfer Protocol (HTTP) requests destined for the origin server can be served by the delegation server;
receiving an HTTP request for content associated with the request-specific content handle from a client network access point (cNAP), wherein the request-specific content handle is calculated from a Hyper Text Transfer Protocol Secure (HTTPS) request from a client; and
sending the secure content to the cNAP in an HTTP response, such that the secure content is inserted into an HTTPS response towards the client.

2. The method of claim 1, wherein the secure content is encrypted with a certificate of the origin server.

3. The method of claim 1, wherein the request-specific content handle comprises a unique mapping from a specific request to a uniform resource identifier (URI) to a specific response.

4. The method of claim 1, wherein the cNAP has a certificate delegation from the origin server.

5. The method of claim 4, wherein the request-specific content handle is calculated at the cNAP.

6. The method of claim 4, wherein the cNAP decrypts the HTTPS request using the delegated certificate.

7. The method of claim 1, wherein a browser plugin at the client has a certificate delegation from the origin server.

8. The method of claim 7, wherein the request-specific content handle is calculated by the browser plugin.

9. The method of claim 7, wherein the browser plugin decrypts the HTTPS request using the delegated certificate.

10. The method of claim 1, wherein the client and the cNAP are co-located.

11. A delegation server for secure content delegation in an information centric network (ICN), the delegation server comprising:
an interface; and
a processor operatively coupled to the interface;
the interface configured to receive secure content from an origin server, wherein the secure content is pushed under a request-specific content handle;
the processor configured to store the secure content in a memory;
the interface further configured to receive name registration authority for a fully qualified domain name (FQDN) from the origin server;
the processor and the interface configured to register to the FQDN, such that one or more Hypertext Transfer Protocol (HTTP) requests destined for the origin server can be served by the delegation server;
the interface further configured to receive an HTTP request for content associated with the request-specific content handle from a client network access point (cNAP), wherein the request-specific content handle is calculated from a Hyper Text Transfer Protocol Secure (HTTPS) request from a client;
the processor further configured to retrieve the secure content from the memory; and
the processor and the interface further configured to send the secure content to the cNAP in an HTTP response, such that the secure content is inserted into an HTTPS response towards the client.

12. The delegation server claim 11, wherein the secure content is encrypted with a certificate of the origin server.

13. The delegation server claim 11, wherein the request-specific content handle comprises a unique mapping from a specific request to a uniform resource identifier (URI) to a specific response.

14. The delegation server of claim 11, wherein the cNAP has a certificate delegation from the origin server.

15. The delegation server of claim 14, wherein the request-specific content handle is calculated at the cNAP.

16. The delegation server of claim 14, wherein the cNAP decrypts the HTTPS request using the delegated certificate.

17. The delegation server claim 11, wherein a browser plugin at the client has a certificate delegation from the origin server.

18. The delegation server claim 17, wherein the request-specific content handle is calculated by the browser plugin.

19. The delegation server 17, wherein the browser plugin decrypts the HTTPS request using the delegated certificate.

20. The delegation server of claim 11, wherein the client and the cNAP are co-located.
